(19) United States
(12) Patent Application Publication
(10) Pub. No.: US 2024/0050988 A1
(43) Pub. Date: Feb. 15, 2024

(54) VIBRATING APPARATUS

(71) Applicant: TUNG KENG ENTERPRISE CO., LTD., Taichung (TW)

(72) Inventor: CHIU-HSIANG LO, TAICHUNG (TW)

(21) Appl. No.: 18/211,242

(22) Filed: Jun. 17, 2023

(30) Foreign Application Priority Data
Aug. 15, 2022 (TW) 111130640
Aug. 15, 2022 (TW) 111208843

(51) Int. Cl. B06B 1/12

(52) U.S. Cl. CPC B06B 1/12

(57) ABSTRACT

A vibrating apparatus includes a base, a frame, two axles and four connectors. The axles are connected to the base and rotatable synchronously. Each of the axles includes two eccentric portions. Each of the connectors is pivotally connected to the frame at an end and receives one of the eccentric portions of one of the axles at another end. The axles are allowed to pivot the connectors, thereby reciprocating the frame relative to the base.

### BACKGROUND OF INVENTION

### 1. Field of Invention

The present invention relates to a vibrating apparatus and, more particularly, to a structurally simple vibrating apparatus.

### 2. Related Prior Art

A conventional vibrating apparatus can be used in a blood circulation-promoting machine, a massage bed or an upright exercise machine. The vibrating apparatus generates vibration to promote circulation of blood in a user. The vibration is horizontal and/or vertical. However, conventional vibrating apparatuses involve complicated structures that are bed for assembly or maintenance.

The present invention is therefore intended to obviate or at least alleviate the problems encountered in the prior art.

### SUMMARY OF INVENTION

It is the primary objective of the present invention to provide a structurally simple vibrating apparatus.

To achieve the foregoing objective, the vibrating apparatus includes a base, a frame, two axles and four connectors. The axles are connected to the base and rotatable synchronously. Each of the axles includes two eccentric portions. Each of the connectors is pivotally connected to the frame at an end and receives one of the eccentric portions of one of the axles at another end. The axles are allowed to pivot the connectors, thereby reciprocating the frame relative to the base.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a vibrating apparatus according to the first embodiment of the present invention;

FIG. 2 is a top view of the vibrating apparatus shown in FIG. 1;

FIG. 3 is a perspective view of an axle of the vibrating apparatus shown in FIG. 1;

FIG. 4 is a side view of the vibrating apparatus shown in FIG. 1;

FIG. 5 is a perspective view of a vibrating apparatus according to the second embodiment of the present invention; and

FIG. 6 is a perspective view of a vibrating apparatus according to the third embodiment of the present invention.

### DETAILED DESCRIPTION OF EMBODIMENTS

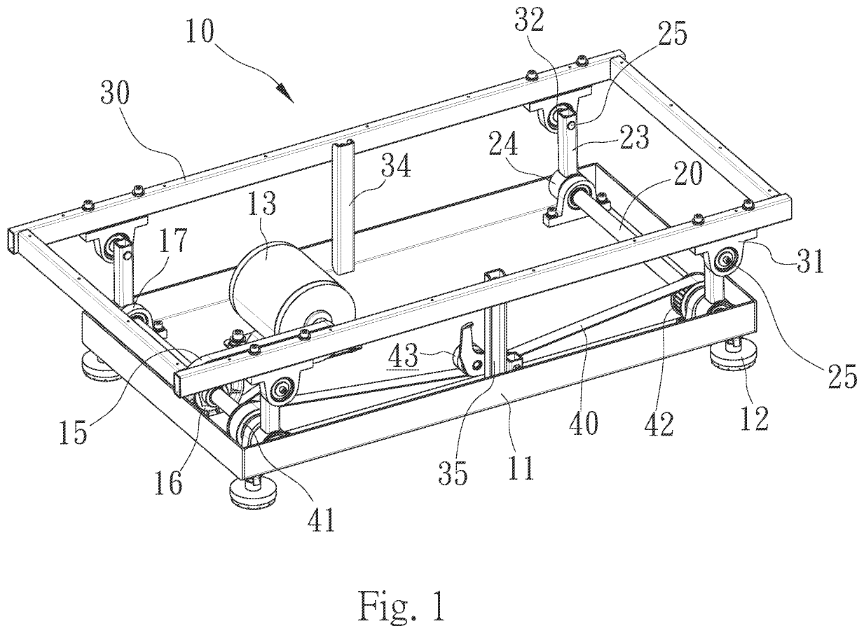

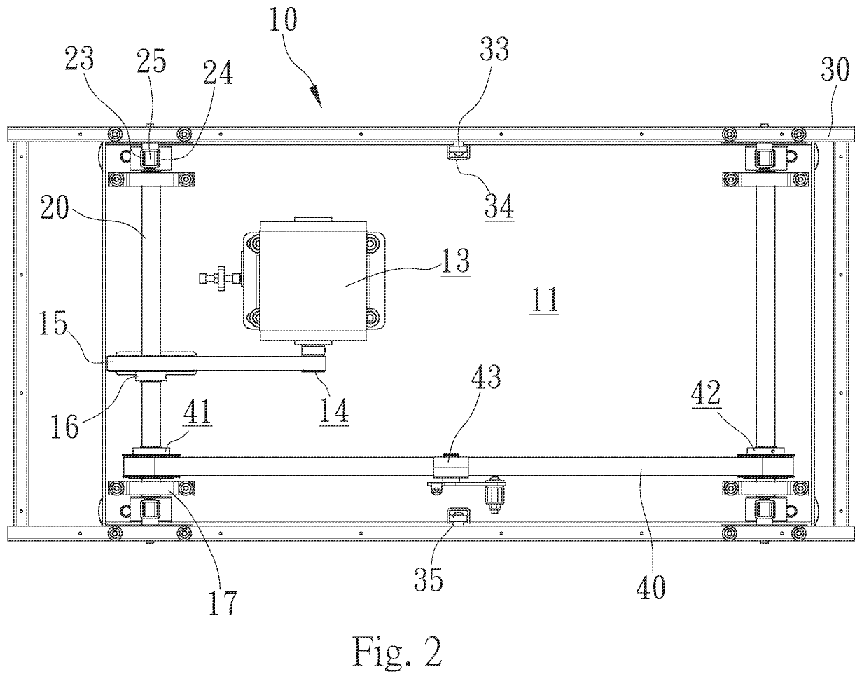

Referring to FIGS. 1 through 4, a vibrating apparatus 10 includes a base 11, two axles 20, four connectors 23 and a frame 30 according to a first embodiment of the present invention. The vibrating apparatus 10 can be used in a blood circulation-promoting machine, a massage machine or an exercise machine.

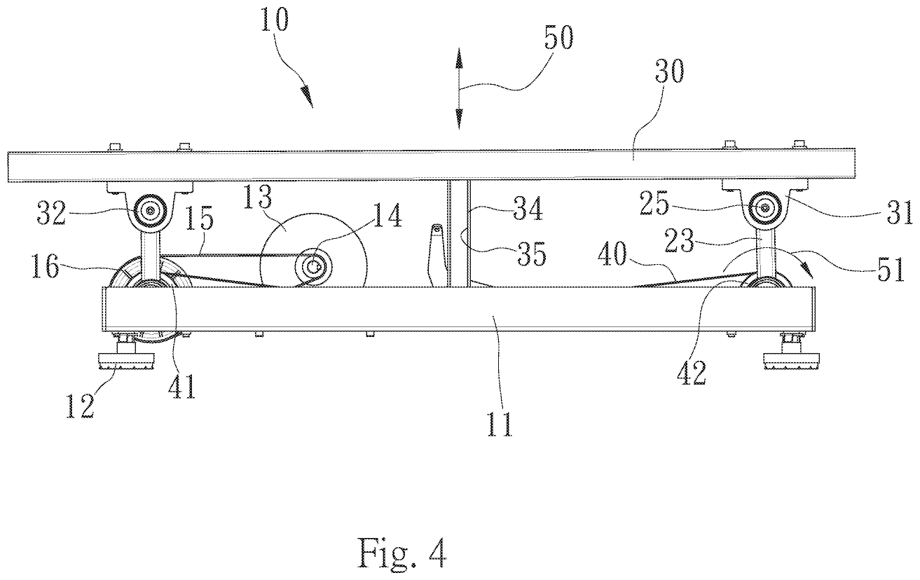

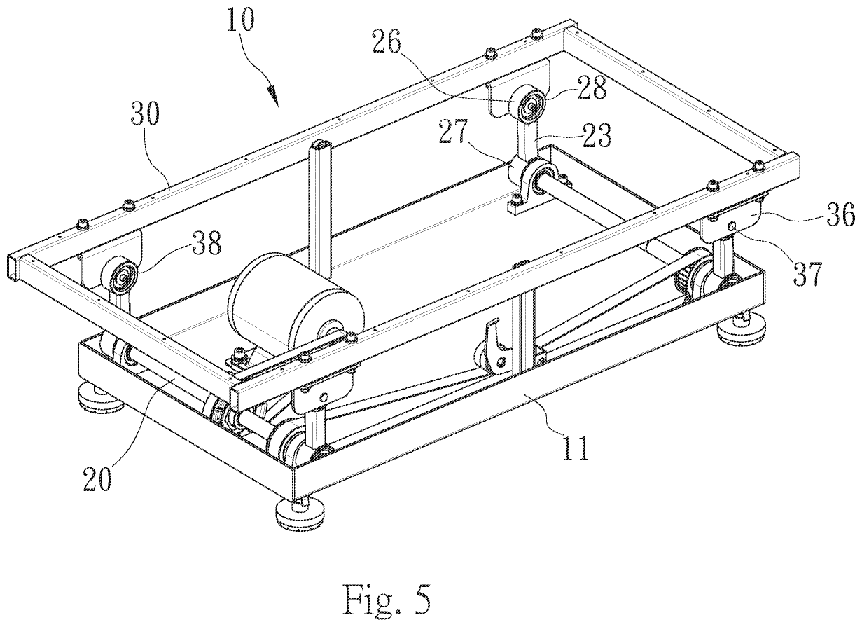

The base 11 is rectangular tray. Four mounts 17 are connected to an upper face of the base 11 near four corners. Four feet 12 are connected to a lower face of the base 11 near the corners. The feet 12 are useful for stable installment of the base 11 on a floor. The frame 30 is equipped with four mounts 31 near four corners. The mounts 31 are located corresponding to the mounts 17. Each of the axles 20 includes two eccentric portions 22 at two ends and two connective portions 21 near the eccentric portions 22. The connective portions 21 of each of the axles 20 are connected to two of the mounts 17. The eccentric portions 22 are not coaxial with the corresponding axle 20. Each of the connectors 23 is connected to a ring 24 at an end and connected to a pivot 25 at another end. The ring 24 receives a bearing 28 (FIG. 5) that can be a ball bearing, a roller bearing or any other proper bearing for receiving one of the eccentric portions 22 of one of the axles 20. The pivot 25 transversely extends through the corresponding connector 23 and is inserted in a bearing 32 inserted in each of the mounts 31. Thus, the base 11, the axles 20, the connectors 23 and the frame 30 together form a structure of the vibrating apparatus 10. The axles 20 eccentrically pivot the connectors 23 in a direction of rotation 50 (FIG. 4).

The vibrating apparatus 10 further includes an electromotor 13 and a transmission. The electromotor 13 includes a mandrel (not numbered). The transmission includes a pulley 14, a leading pulley 16, a belt 15, a precise-motion belt 40, a following pulley 41, a tailing pulley 42 and a tension pulley 43.

The pulley 14 is coaxially connected to the mandrel of the electromotor 13. The leading pulley 16 and the following pulley 41 are supported on one of the axles 20 while the tailing pulley 42 is supported on the remaining one of the axles 20. The belt 15 is wound around the pulley 14 and the leading pulley 16. The precise-motion belt 40, which can be referred to as the “timing belt”, is wound around the following pulley 41 and the tailing pulley 42. The tension pulley 43 is supported on the base 11 and in contact with the precise-motion belt 40. The tension pulley 43 is operable to render tension in the precise-motion belt 40 in a proper range. Thus, the electromotor 13 is operable to synchronously rotate the axles 20 via the transmission.

In another embodiment, two sprockets can be used instead of the following pulley 41 and the tailing pulley 42 and a chain can be used instead of the precise-motion belt 40. Obviously, such a chain is wound around such sprockets.

For stability, the vibrating apparatus 10 further includes two pulleys 33 and two columns 34. The pulleys 33 are located in the frame 30 and connected to two lateral bars (not numbered) of the frame 30. Similarly, the columns 34 are connected to two lateral bars (not numbered) of the base 11 by welding for example. Each of the columns 34 includes a track 35 in the form of a groove for receiving a corresponding one of the pulleys 33. Preferably, the angle between each of the columns 34 and the corresponding bar of the base 11 is 90°. Thus, the frame 30 is only allowed to move vertically up and down relative to the base 11 in a direction of vibration 51 (FIG. 4).

However, in another embodiment, the angle between each of the columns 34 and the corresponding bar of the base 11 is larger or smaller than 90°. Thus, the frame 30 is allowed to reciprocate both vertically and horizontally relative to the base 11.

The pulleys 33, which are restrained by the tracks 35, and the connectors 23, which are located near four corners of the base 11, together keep the frame 30 right above the base 11, not biased horizontally. The tracks 35 tend to keep the reciprocation of the pulleys 33 vertical to prevent the frame 30 from excessive vibration relative to the base 11.

Referring to FIG. 5, the vibrating apparatus 10 according to a second embodiment. The second embodiment is like the first embodiment except for a few things. Firstly, each of the connectors 23 is connected to an upper ring 26 at an upper end and connected to a lower ring 27 at a lower end.

Secondly, the upper ring 26 receives a bearing 28. A pivot 37 is connected to each of four mounts 36 connected to the frame 30 adjacent to four corners. Each of the pivots 37 is inserted in the bearing 28 inserted in each of the upper rings 26. A C-clip 38 is engaged with each of the pivots 37 to keep the pivot 37 in the corresponding upper ring 26, without affecting rotation of the corresponding upper ring 26 around the pivot 37.

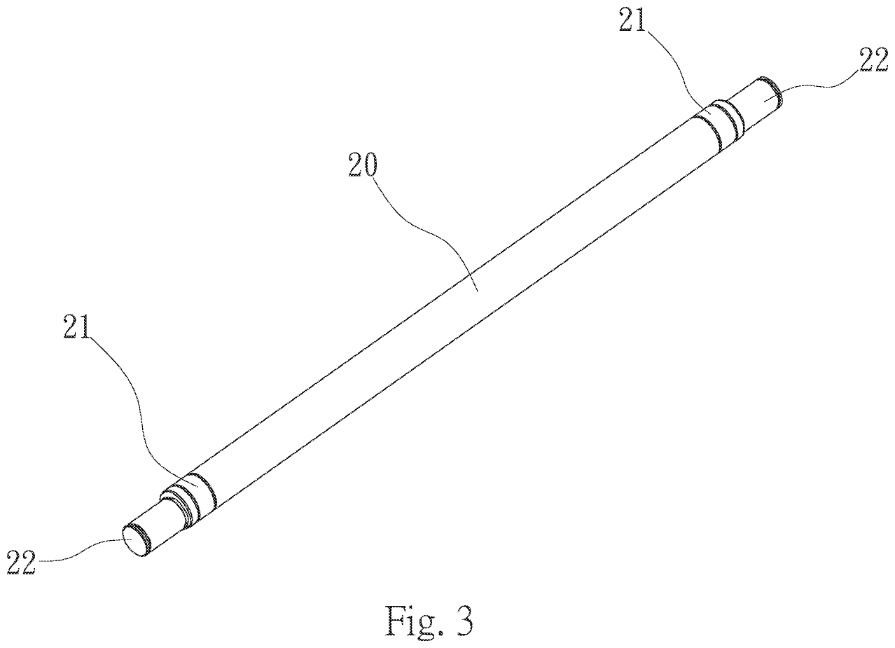

Thirdly, each of the lower rings 27 receives a bearing 28 that receives one of the eccentric portions 22 (FIG. 3). Thus, the axles 20 rotate the lower rings 27 and the connectors 23 eccentrically, i.e., the frame 30 is allowed to regularly and continuously vibrates relative to the base 11.

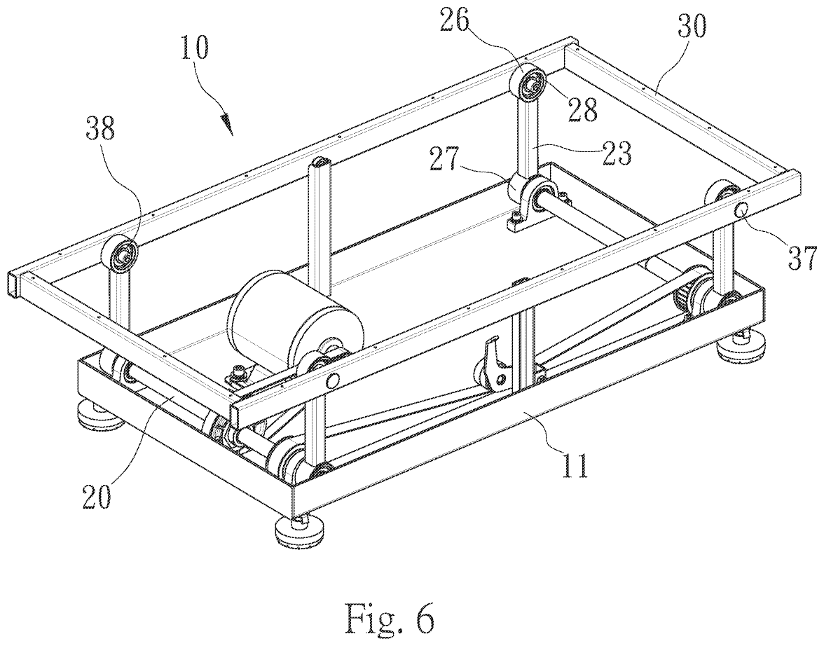

Referring to FIG. 6, the vibrating apparatus 10 according to a third embodiment. The third embodiment is like the second embodiment except for omitting the mounts 37. The pivots 37 are connected to the lateral bars of the frame 30.

The present invention has been described via the illustration of the embodiments. Those skilled in the art can derive variations from the embodiments without departing from the scope of the present invention. Therefore, the embodiments shall not limit the scope of the present invention defined in the claims.

1. A vibrating apparatus comprising:
a base;
a frame;
two axles connected to the base, wherein the axles are rotatable synchronously, and each of the axles comprises two eccentric portions; and
four connectors each of which is pivotally connected to the frame at an end and pivotally connected to one of the eccentric portions of one of the axles at another end so that the axles are operable to pivot the connectors, thereby reciprocating the frame relative to the base.

2. The vibrating apparatus according to claim 1, further comprising:
a following pulley supported on one of the axles;
a tailing pulley supported on the remaining one of the axles; and
a precise-motion belt wound around the following and tailing pulleys to render the axles to synchronously rotatable.

3. The vibrating apparatus according to claim 2, further comprising a tension pulley supported on the base and in contact with the precise-motion belt.

4. The vibrating apparatus according to claim 2, further comprising:
an electromotor supported on the base;
a driving pulley operatively connected to the electromotor;
a leading pulley connected to the one of the axles on which the following pulley is supported; and
a belt wound around the driving and leading pulleys.

5. The vibrating apparatus according to claim 1, further comprising rings and pivots, wherein each of the connectors is connected to one of the rings at an end and connected to one of the pivots at another end, wherein the pivots are connected to the frame, and wherein each of the rings receives one of the eccentric portions of one of the axles.

6. The vibrating apparatus according to claim 5, further comprising mounts connected to the frame, wherein the pivots are connected to the mounts.

7. The vibrating apparatus according to claim 1, further comprising pivots connected to the frame, wherein each of the connectors comprises an upper ring for receiving one of the pivots and a lower ring for receiving one of the eccentric portions of one of axles.

8. The vibrating apparatus according to claim 7, further comprising bearings, wherein each of the bearings is arranged between the upper ring of one of the connectors and one of the pivots.

9. The vibrating apparatus according to claim 7, further comprising mounts connected to the frame and bearings inserted in the mounts, wherein each of the pivots is inserted in one of the bearings.
